(19) United States
(12) Patent Application Publication
(10) Pub. No.: US 2005/0170324 A1
(43) Pub. Date: Aug. 4, 2005

(54) Invisible ink quiz game

(76) Inventors: Sun Yu, Berkley, MI (US); David Perrin, Troy, MI (US)

Correspondence Address: GIFFORD, KRASS, GROH, SPRINKLE & CITKOWSKI, P.C, PO BOX 7021, TROY, MI, 48007-7021, US

(21) Appl. No.: 10/770,826

(22) Filed: Feb. 3, 2004

(51) Int. Cl. G09B 3/00

(52) U.S. Cl. 434/331

(57) ABSTRACT

A reusable sequential information display device includes a printed substrate that includes on a display surface with indicia visualized under ambient light to form a first informational statement. Indicia formed of an ink visualized under light wavelengths of less than 420 nanometers is also applied to the display surface to form a second informational statement. A reader contains a light-emitting diode producing an emission wavelength of less than or equal to the wavelength required to visualize the invisible ink. The light-emitting diode, a battery and a switch for selectively forming an electrical circuit between the light-emitting diode and battery are located within a reader. A query-answer educational game is formed and optionally includes a light-emission timer and/or a sound synthesizer.

### FIELD OF THE INVENTION

The present invention generally relates to a quiz game and, in particular, to a game device where the answer is written in an ink visible only under ultraviolet light illumination.

### BACKGROUND OF THE INVENTION

Quiz games have traditionally involved a mechanical action to reveal the answer to a query. This mechanical action in various forms has included flipping to the reverse side of a card or displacing an opaque covering obscuring a view of the answer while the query is being examined. In the case of a flashcard that must be flipped to reveal the answer, the speed at which queries are answered, such as arithmetic tables, is often limited by manual dexterity and not comprehension of the subject matter. While it is known to bind a series of cards in order to reduce disorganization, the binding of flip cards tends to further slow a query-answer cycle rate. While a cover slip obscuring an answer is effective where a query and an answer are arranged in tabular form on a single page, this approach requires a table or other support for the page. It is therefore not amenable to transitory use.

Another approach to the creation of a quiz game involves the use of an answer being written in an invisible ink that is permanently developed and rendered visible by application of a developing chemical. The developing chemical is most often provided through a marking pen or similar writing instrument. While the development of invisible ink overcomes many of the limitations of flip cards and cover slips, the development process has characteristics that have limited the acceptance of this process. The development process is comparatively slow in rendering the invisible ink readable. Additionally, the permanent nature of the development process and the resulting expense of one-time use quiz materials renders the developable invisible ink systems impractical for repetitive usage learning materials.

Thus, there exists a need for a portable quiz game suitable for repeated use without resort to card flipping in order to observe a query-answer pair.

### SUMMARY OF THE INVENTION

A reusable information display device has a printed substrate defining a display surface. A visible ink is applied to the display surface to form a first informational statement. An invisible ink that becomes visible under light having a wavelength of between 350 and 420 nanometers is applied to the display surface to form a second informational statement. The printed substrate engages a reader that exposes the display surface to a light-emitting source producing an emission wavelength capable of visualizing the second informational statement written in invisible ink. A power source is provided to energize the light-emitting source. A switch selectively forms an electrical circuit between the light-emitting source and the power source.

A process for reusably displaying information that is well suited for educational quiz games begins with inserting a printed substrate into a reader. The printed substrate has a display surface imprinted with visible ink forming a first informational statement and an invisible ink visualized under a light having a wavelength of between 350 and 420 nanometers to form a second informational statement. The first informational statement is read under ambient visible light. A light-emitting source having a wavelength less than or equal to the wavelength necessary to visualize the invisible ink is then activated and shined upon the display surface to allow for the reading of the second informational statement. The light-emitting source is located within the reader and projected onto the printed substrate display surface.

### BRIEF DESCRIPTION OF THE DRAWINGS

FIG. 1 is a perspective view of an invisible ink quiz game according to the present invention;

FIG. 2 is an exploded view of the quiz game depicted in FIG. 1; and

FIG. 3 is a perspective view of an alternate embodiment of an invisible ink quiz game according to the present invention.

### DETAILED DESCRIPTION OF THE PREFERRED EMBODIMENTS

The present invention has utility as an educational or a recreational query-answer game. According to the present invention, a sequential information display device is rendered reusable by printing with invisible ink on a display surface a first informational statement and printing with an ink visible under light having a wavelength between 350 and 420 nanometers a second informational statement on the same display surface. A reader incorporating a light-emitting source having an emission wavelength less than or equal to the light required to visualize the invisible ink engages the display surface. By activating a switch found in the reader, an electrical circuit is formed between the light source and a power source therefor to illuminate the ink and thereby make the second informational statement readable. A query-answer game according to the present invention is reusable and operative independent of display surface flipping to read the second informational statement.

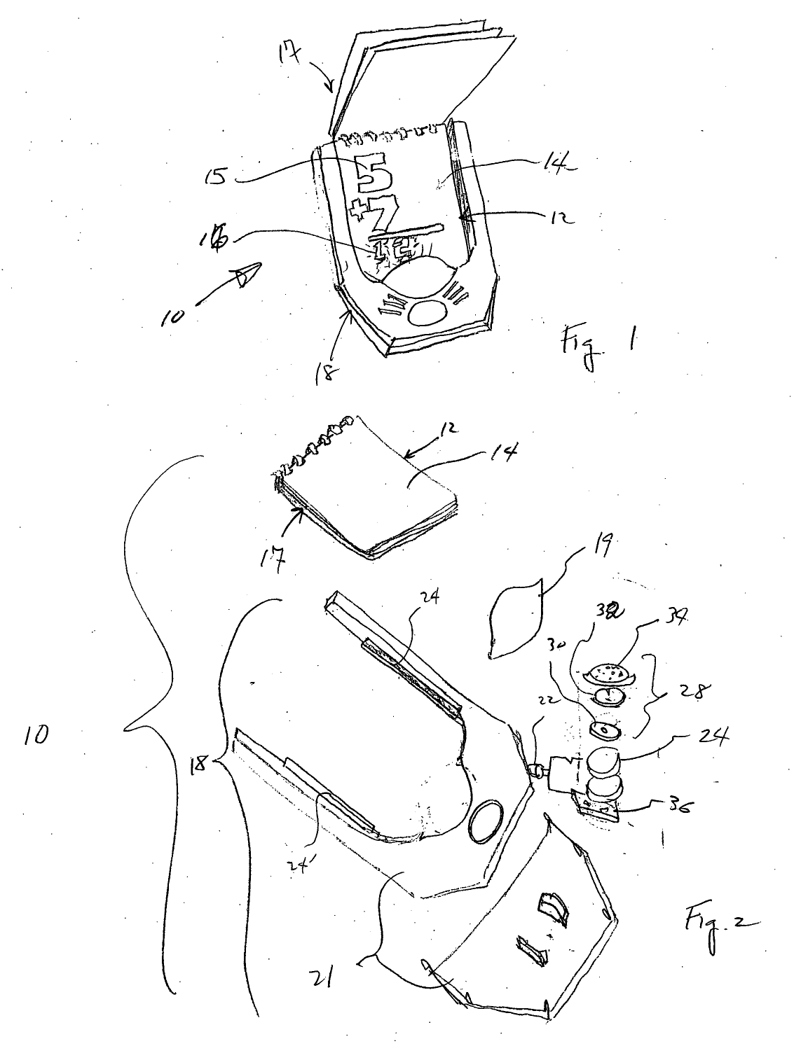

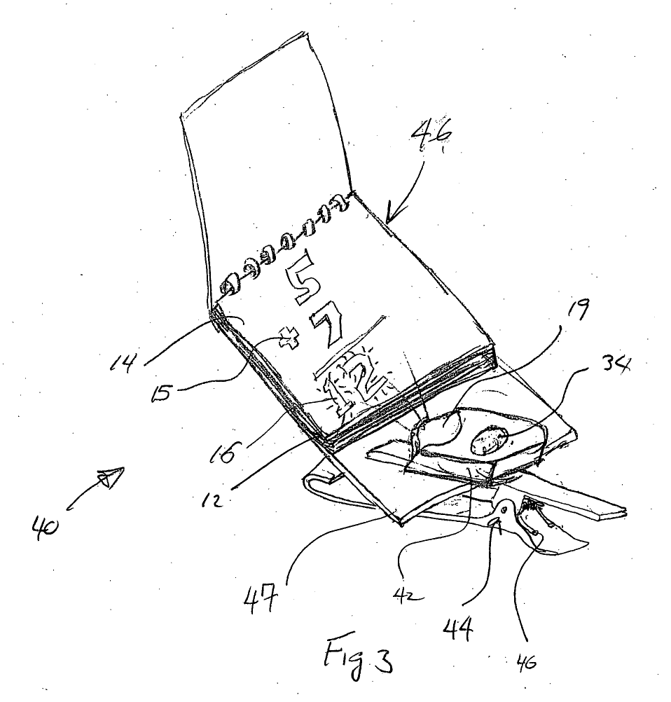

Referring now to FIGS. 1 and 2, an inventive reusable information display device is shown generally at 10. A substrate 12 has a printed display surface 14. The display surface 14 is printed with visible indicia formed from a conventional ink, paint, or pigment that is visible under ambient sunlight, fluorescent light or incandescent light. While it is appreciated that the ink visible under ambient light can be formed in an endless number of letters, words, representative drawings or combinations thereof, in a preferred embodiment, the ink visible under ambient light forms a query prompting a user response.

A substrate 12 according to the present invention illustratively includes paper, cardboard, acetate, metal and a variety of plastic sheet materials. It is appreciated that a sheet material is optionally formed into, or adhered to a three-dimensional shape such as a tetrahedron, cube, icosahedron or the like.

The substrate 12 is also printed with indicia 16 essentially invisible under ambient natural, fluorescent, or incandescent light while being visualized by incident light having a wavelength less than 420 nanometers. Preferably, the incident light to visualize these indicia is between 350 and 420 nanometers. While indicia formed from an ink, paint or pigment that is visible only under light having a wavelength of less than 420 nanometers is readily formed into a variety of printed indicia, preferably, such indicia are formed to create a response or answer to the query posed in ink visualized under ambient, fluorescent or incandescent light.

The substrate 12 is readily bound with other substrate sheets to form a booklet 17. Such a booklet is illustratively formed with conventional bindings illustratively including: spiral, adhesive, sound and ring clip. Through the binding of multiple substrates 12, a course of query and answers are practiced by a user. In a preferred embodiment of a booklet collection of inventive substrates, the substrates are removable from the booklet and reordered. The ability to reorder substrates is advantageous in preventing answer-order memorization or to segregate queries to which incorrect answers were provided.

A reader 18 is adapted to expose the printed substrate to the emission from a light-emitting source 22 contained within the reader 18. The emission from the light-emitting source has a wavelength of less than or equal to the wavelength required to visualize the invisible ink. The light emitting source 22 illustratively includes a light-emitting diode (LED), cold cathode fluorescent lamp (CCFL), fluorescent lamp, incandescent bulb, noble gas, and mercury vapor arc lamps. Preferably, the light-emitting source 22 is a light-emitting diode (LED). A reader housing 21 supports therein a light-emitting source 22 positioned in a reader 18 such that upon a substrate 12 being supported on opposing ledges 24 and 24′, illumination from the light-emitting source is directed onto the substrate so as to visualize the invisible ink indicia 16. Preferably, a translucent cover 19 affords an indication of light-emitting source activation while preventing light emission towards a user. More preferably, emission from the light-emitting source 22 towards the surface 14 is not transmitted through another material. Light-emitting diodes having an emission wavelength of less than 420 nanometers illustratively include gallium nitride and gallium indium nitride. A power source 24 is provided for generating a sufficient voltage to power the light-emitting source 22. A power source 24 according to the present invention is appreciated to include a single battery, multiple batteries linked in series, and line power provided by way of an AC adaptor. Batteries operative in the present invention illustratively include alkaline, lithium, metal hydride, polymeric and nickel cadmium. Preferably, the battery is a lithium battery. A switch 28 is provided for selectively forming an electrical circuit between the light-emitting source 22 and the battery to activate the light-emitting diode. Preferably, the switch is a dome switch including an insulating washer 30, a dome spring 32 and an elastomeric switch cover 34.

Preferably, a printed circuit board 36 is inserted intermediate between the light-emitting source 22 and the battery circuit where the printed circuit board 36 includes a timer circuit operative to a periodic timed pulse of emission from the light-emitting source 22 thereby illuminating an answer at a preselected and optionally user-selected interval. Optionally, the printed circuit board 36 includes a step-up voltage or step-down voltage circuit that serves to take the input voltage from the battery and output a voltage to the light-emitting source that is between the voltage necessary to induce emission of the light-emitting source and 20 percent beyond. More preferably, the output voltage is less than 10 percent greater than the emission voltage for the light-emitting source. It is appreciated that a sound synthesizer (not shown) is also powered through the power source 24 or a separate battery.

In addition to being capable of operation from battery power, it is appreciated that the present invention is also readily powered from line power or the cigarette lighter of a vehicle upon sufficient voltage transformation in compliance with the demands of the light-emitting source.

Referring now to FIG. 3, an alternate embodiment of the present invention is depicted generally at 40 where like numerals correspond to the description thereof given with respect to FIGS. 1 and 2. A reader 42 containing a light-emitting source, battery, switch and printed circuit board as described with respect to FIGS. 1 and 2 has coupled thereto a clip 44 that is biased by a spring 46. The clip 44 is adapted to engage an anchoring tab extending from a substrate sheet. Preferably, the substrates 12 are bound as a booklet 46 with the bottom booklet sheet 47 extending beyond the other substrates 12 such that upon the reader engaging the rearmost substrate 47, all of the substrate sheets may be flipped without the need for repositioning the reader 42.

Each of the references mentioned within the specification are indicative of the level and the skill in the art to which the invention pertains. Each reference is hereby incorporated by reference to the same extent as if each individual reference was individually and explicitly incorporated by reference.

It will be obvious to one of skill in the art upon reading the specification that various obvious modifications and variations in the invention can be made without departing from the spirit thereof. Such modifications and variations are intended to be encompassed within the scope of the appended claims.

1. A reusable information display device comprising:
a printed substrate having a display surface;
a visible ink applied to the display surface to form a first informational statement;
an invisible ink visualized under a light having a wavelength of between 350and 420 nanometers, said invisible ink applied to the display surface to form a second informational statement;
a reader adapted to expose the display surface;
a light-emitting source having an emission wavelength of less than or equal to that of the light required to visualize said invisible ink, said light-emitting source located within said reader and projected to the display surface;
a power source for said light-emitting source; and
a switch for selectively forming an electrical circuit between said light-emitting source and said power source.

2. The device of claim 1 wherein said printed substrate is a booklet.

3. The device of claim 1 wherein the first informational statement and second informational statement together form a query-answer pair.

4. The device of claim 1 wherein said reader is hand held.

5. The device of claim 1 further comprising a light-emitting source activation timer.

6. The device of claim 1 further comprising a sound synthesizer.

7. The device of claim 1 further comprising a spring-biased clip attached to said reader and adapted to engage said printed substrate therein.

8. The device of claim 1 further comprising a sound synthesizer within said reader.

9. The device of claim 1 wherein said power source is a battery.

10. The device of claim 9 wherein said battery is located within said reader.

11. The device of claim 1 wherein said power source is line power.

12. The device of claim 1 further comprising a printed circuit board comprising a voltage step-up or step-down voltage circuit intermediate between said power source and said light-emitting source.

13. The device of claim 1 wherein said light-emitting source is a light-emitting diode.

14. A process for reusably displaying information comprising the steps of:
coupling a printed substrate and a reader, said substrate having a display surface of said printed substrate imprinted with visible ink forming a first informational statement and an invisible ink visualized under light having a wavelength of between 350 and 420 nanometers to form a second informational statement;
reading the first informational statement under ambient visible light;
activating a light-emitting source having a wavelength less than or equal to the wavelength necessary to visualize said invisible ink, the light-emitting source located within said reader and projected onto the display surface; and
reading the second informational statement.

15. The process of claim 14 wherein the activation of the light-emitting source is in a timed pulse manner.

16. The process of claim 15 wherein the timed pulse manner is periodic.

17. The process of claim 16 wherein the periodic timed pulse manner is at a user-selected interval.

18. The process of claim 14 wherein the light-emitting source is a battery or line power.
